(19) United States
(12) Patent Application Publication
(10) Pub. No.: US 2004/0125422 A1
(43) Pub. Date: Jul. 1, 2004

(54) Data driver with gamma correction

(76) Inventors: Bo-Wen Wang, Taipei (TW); Ming-Daw Chen, Hsinchu (TW); Shang-Li Chen, Hsinchu (TW)

Correspondence Address: BIRCH STEWART KOLASCH & BIRCH, PO BOX 747, FALLS CHURCH, VA, 22040-0747, US

(21) Appl. No.: 10/623,645

(22) Filed: Jul. 22, 2003

(30) Foreign Application Priority Data
Oct. 8, 2002 (TW) 91123210

(51) Int. Cl. G06F 3/05; H04N 1/48

(52) U.S. Cl. 358/519; 358/504

(57) ABSTRACT

A data driver of a display forming an image frame by sequentially scanning horizontal lines. The data driver comprises a shift register receiving image data of three primary colors in serial and outputting them in parallel within each scan duration, a sample and hold register acquiring the image data from the shift register, a gamma multiplexer outputting gamma reference voltages for the three primary colors in a predetermined sequence within each scan duration, three DACs receiving the image data of the three primary colors from the sample and hold register and the gamma reference voltages from the gamma multiplexer, and outputting calibrated image signals of the three primary colors, respectively, and three buffers receiving the calibrated image signals from the three digital-to-analog converters in the sequence of the primary colors.

### BACKGROUND OF THE INVENTION

1. Field of the Invention

The present invention relates to a data driver in a display and particularly to a data driver with gamma correction.

2. Description of the Prior Art

Images are manipulated as a set of brightness values on a computer display as 0, 1, 2, 3, 4 . . . 255, or electrically in a video system 0.1 Volts, 0.2V, 0.3V . . . 1V. It may be thought that 8 is twice as bright as 4, or that 0.6 Volts is twice as bright as 0.3 Volts. The former case is sometimes true, while the latter is never true. The relationship of voltage to brightness is logarithmic, and it varies between different equipment. Gamma correction is used in the data driver of the display to eliminate such non-linearity. A gamma value of 1.0 is a linear relationship, while the recommended NTSC standard of 2.2 is quite curved. Most systems are somewhere between these values.

A conventional data driver uses the same gamma curve, as shown in FIG. 1, for the three primary colors R, G, and B, which has the advantage of reduced cost. However, there are some drawbacks with the conventional data driver. First, it is impossible to apply gamma corrections with different curves to the image data of the three primary colors, and the color image cannot be optimally calibrated. Second, using the same gamma curve for the three primary colors yields an image with an improper color temperature.

### SUMMARY OF THE INVENTION

The object of the present invention is to provide a data driver applying gamma correction with different gamma reference voltages to image data of the three primary colors, whereby an optimally calibrated color image with adjustable color temperature can be generated.

The present invention provides a first data driver of a display forming an image frame by sequentially scanning horizontal lines, the data driver comprising a shift register receiving image data of three primary colors in serial and outputting the image data of the three primary colors in parallel within each of scan durations of the horizontal lines, a sample and hold register acquiring the image data from the shift register, a gamma multiplexer outputting gamma reference voltages for the three primary colors in a sequence of the primary colors within each of the scan durations of the horizontal lines, three digital-to-analog converters for gamma calibration, receiving the image data of the three primary colors from the sample and hold register and the gamma reference voltages for the three primary colors from the gamma multiplexer, and outputting calibrated image signals of the three primary colors, respectively, and three buffers respectively receiving the calibrated image signals of the three primary colors from the three digital-to-analog converters, in the sequence of the primary colors.

The present invention provides a second data driver of a display forming an image frame by sequentially scanning horizontal lines, the data driver comprising a shift register receiving image data of three primary colors in serial and outputting the image data of the three primary colors in parallel within each of scan durations of the horizontal lines, a sample and hold register acquiring the image data of the three primary colors from the shift register, a first multiplexer receiving the image data of the three primary colors from the sample and hold register and outputting them in a sequence of the primary colors within each of the scan durations of the horizontal lines, a second multiplexer outputting gamma reference voltages for the three primary colors in the sequence of the primary colors within each of the scan durations of the horizontal lines, a digital-to-analog converter for gamma calibration, receiving the image data from the first multiplexer and the gamma reference voltages from the second multiplexer, and outputting calibrated image signals of the three primary colors, and a buffer receiving the calibrated image signals from the digital-to-analog converter and outputting the calibrated image signals in the sequence of the primary colors.

The present invention provides a third data driver of a display forming an image frame by sequentially scanning horizontal lines, the data driver comprising a shift register receiving and outputting image data of the three primary colors in a sequence of the primary colors within a scan duration of one of the horizontal lines, a sample and hold register acquiring the image data from the shift register, a gamma multiplexer outputting gamma reference voltages for the primary color in the sequence of the primary colors, a digital-to-analog converter for gamma calibration, receiving the image data from the sample and hold register and the gamma reference voltages from the gamma multiplexer, and outputting calibrated image signals of the three primary colors, and a buffer receiving the calibrated image signals from the digital-to-analog converter and outputting the calibrated image signals in the sequence of the primary colors.

The present invention provides a fourth data driver of a display forming an image frame composed of sub-frames of three primary colors by sequentially scanning horizontal lines for each sub-frame, the data driver comprising a shift register receiving and outputting image data of one of the three primary colors within each scan duration of the horizontal lines, a sample and hold register acquiring the image data from the shift register, a gamma multiplexer outputting gamma reference voltages for the primary color to which the image data from the shift register belongs, a digital-to-analog converter for gamma calibration, receiving the image data from the sample and hold register and the gamma reference voltage from the gamma multiplexer, and outputting a calibrated image signal, and a buffer receiving the calibrated image signal from the digital-to-analog converter.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows a gamma curve used in a conventional data driver.

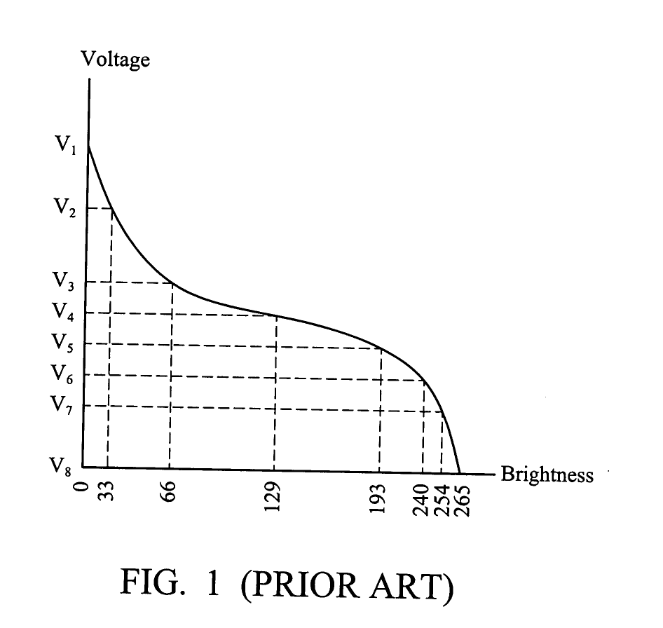

FIG. 2 is a diagram showing the timing of signals used in the data driver according to a first embodiment of the invention.

FIG. 3 is a diagram showing a data driver according to the first embodiment of the invention.

FIG. 4 is a diagram showing a data driver according to the second embodiment of the invention.

FIG. 5 is a diagram showing a data driver according to the third embodiment of the invention.

FIG. 6 is a diagram showing the timing of signals used in a data driver according to a fourth embodiment of the invention.

### DETAILED DESCRIPTION OF THE INVENTION

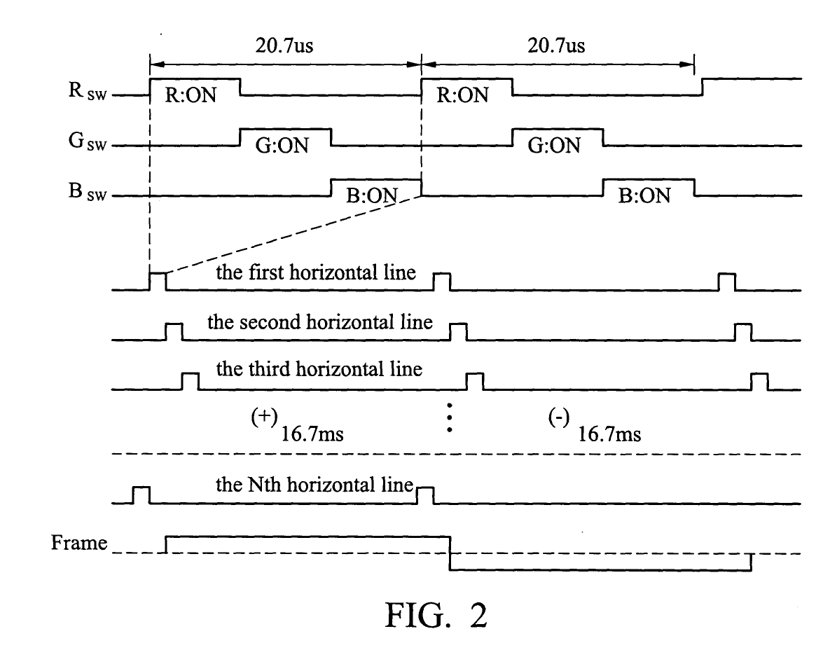

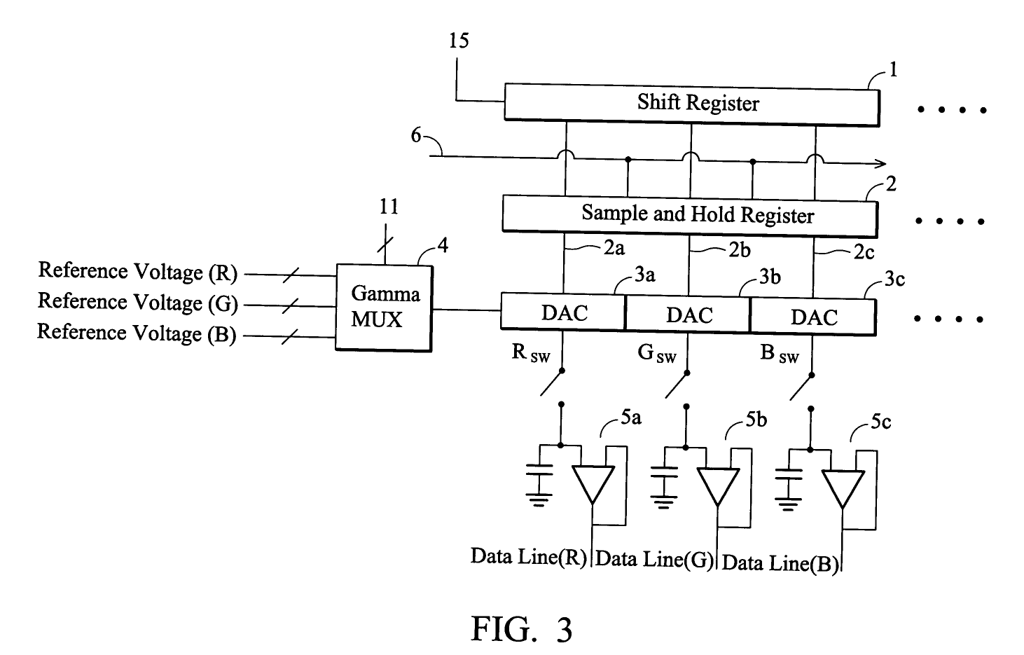

FIG. 2 is a diagram showing the timing of signals used in the data driver according to a first embodiment of the invention. Each of the scan durations of the horizontal lines is divided into three time slots, R:ON, G:ON and B:ON. The switches Rsw, Gsw, and Bsw of the unit gain buffer 5a, 5b and 5c shown in FIG. 3 are closed (turned on) during the time slots R:ON, G:ON and B:ON for the image data of the three primary colors, red, green and blue, to be fed into the sub-pixels, respectively. For example, the scan duration is 20.7 μs in XGA so that each of the time slots R:ON, G:ON and B:ON are 6.9 μs.

FIG. 3 is a diagram showing a data driver according to the first embodiment of the invention. The data driver includes a shift register 1, a sample and hold register 2, three digital-to-analog converters 3a, 3b and 3c, a gamma multiplexer 4, three unit gain buffers 5a, 5b and 5c, and a data bus 6. The shift register 1 receives image data of the three primary colors in serial through a serial data bus 15 and outputs the image data of the three primary colors in parallel within each of scan durations of the horizontal lines. The sample and hold register 2 is turned on by the shift register 1 and acquires the image data from the shift register 1 through the data bus 6. The gamma multiplexer 4 outputs gamma reference voltages for the three primary colors in a predetermined sequence of the primary colors within one scan duration according to a selection signal from the line 11. The gamma reference voltages for the three primary colors are output during corresponding time slots R:ON, G:ON and B:ON. The digital-to-analog converters 3a, 3b and 3c receive the image data of and the gamma reference voltages for the three primary colors respectively from the sample and hold register 2 and the gamma multiplexer 4, and output calibrated image signals of the three primary colors, respectively. The unit gain buffers 5a, 5b and 5c respectively receive the calibrated image signals of the three primary colors from the digital-to-analog converters 3a, 3b and 3c through the switches Rsw, Gsw and Bsw in the predetermined sequence of the primary colors. The switches Rsw, Gsw and Bsw are closed during the corresponding time slots R:ON, G:ON and B:ON, whereby the sub-pixel data is output to the pixel array through the R, G and B data lines.

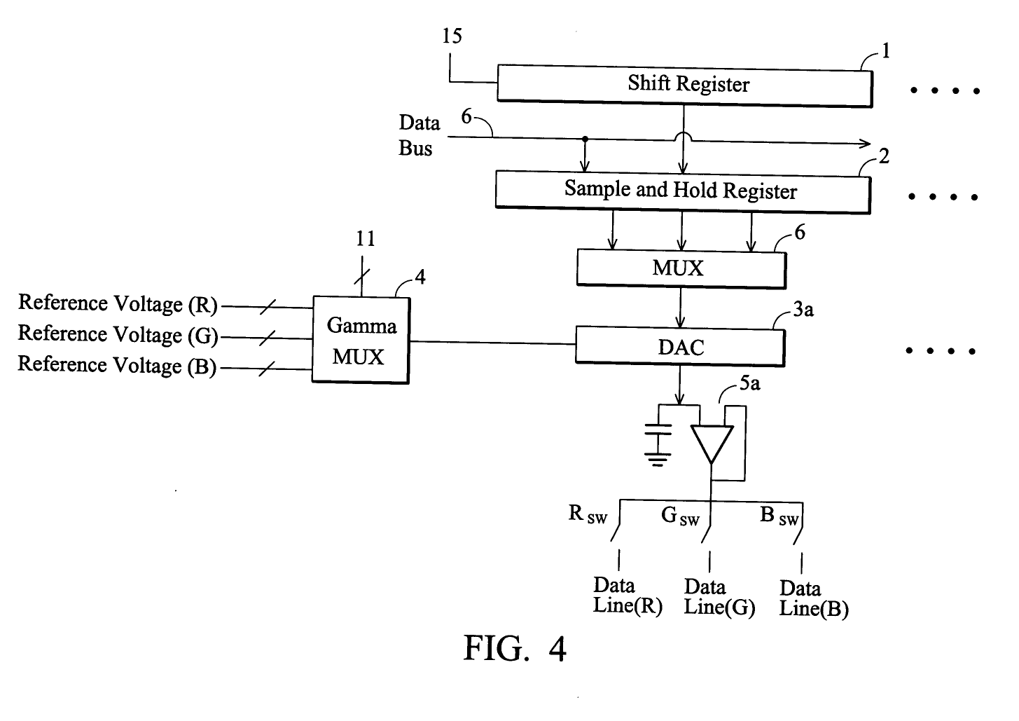

FIG. 4 is a diagram showing a data driver according to the second embodiment of the invention. It is similar to that shown in FIG. 3 except that there is an additional multiplexer 6, and only one DAC 3a and unit gain buffer 5a are used. This circuit configuration applies to a data driver having a unit gain buffer with high driving ability. The shift register 1 receives image data of the three primary colors in serial through the serial data bus 15 and outputs the image data of the three primary colors within each of scan durations of the horizontal lines. The sample and hold register 2 is turned on by the shift register 1 and acquires the image data from the shift register 1 through the data bus 6. The multiplexer 6 receives the image data of the three primary colors from the sample and hold register 2 and outputs them in a predetermined sequence of the primary colors within each of the scan durations of the horizontal lines. The gamma multiplexer 4 outputs gamma reference voltages for the three primary colors in the sequence of the primary colors within each of the scan durations of the horizontal lines according to the selection signal on the line 11. The digital-to-analog converter 3a receives the image data from the multiplexer 6 and the gamma reference voltages from the gamma multiplexer 4, and outputs calibrated image signals of the three primary colors. The unit gain buffer 5a receives the calibrated image signals from the digital-to-analog converter 3a and outputs the calibrated image signals in the sequence of the primary colors through the switches Rsw, Gsw and Bsw. Thus, the number of the DACs and buffers are reduced to ⅓ of that in FIG. 3.

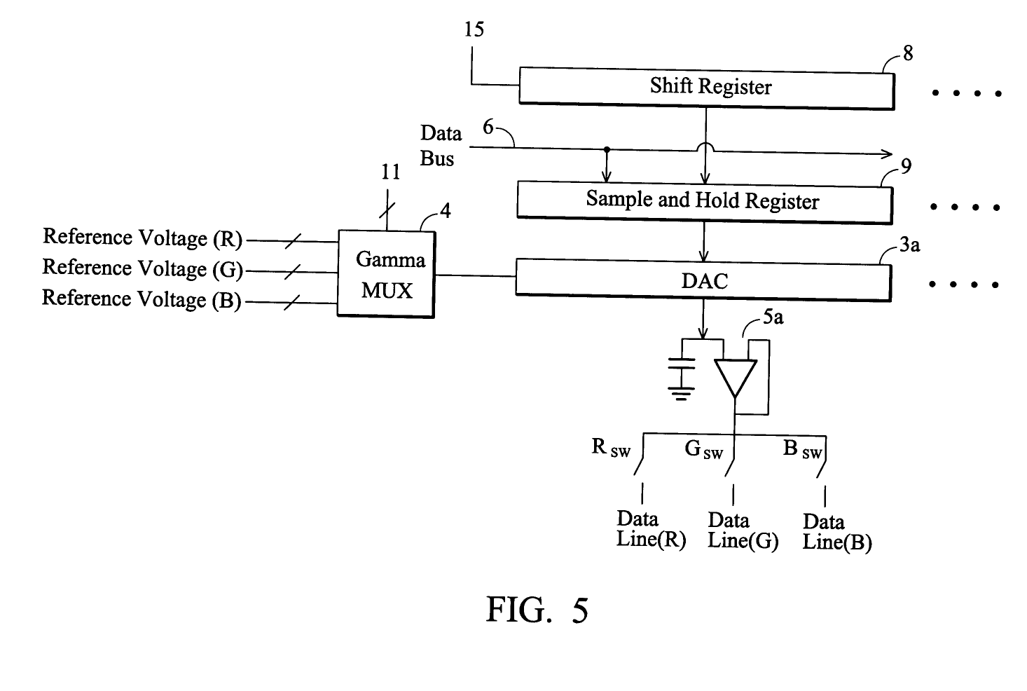

FIG. 5 is a diagram showing a data driver according to the third embodiment of the invention. It is similar to that shown in FIG. 4 except that there is no additional multiplexer 6. This circuit configuration applies to a data driver having a unit gain buffer with high driving ability and, on the serial data bus 15, receiving image data with a format wherein the sub-pixel data for one primary color is disposed within its corresponding time slot. It is noted that the image data format is different from that in FIGS. 3 and 4. The shift register 8 receives and outputs image data of the three primary colors in a predetermined sequence of the primary colors within a scan duration of one of the horizontal lines. The sample and hold register 9 is turned on by the shift register 8 and acquires the image data from the shift register 8 through the data bus 6. The gamma multiplexer 4 outputs gamma reference voltages for the primary color in the sequence of the primary colors. The digital-to-analog converter 3a receives the image data from the sample and hold register 9 and the gamma reference voltages from the gamma multiplexer 4, and outputs calibrated image signals of the three primary colors. The unit gain buffer 5a receiving the calibrated image signals from the digital-to-analog converter 3a and outputs the calibrated image signals in the sequence of the primary colors through the switches Rsw, Gsw and Bsw. Thus, the number of the elements in this circuit is reduced further than that in FIG. 4.

It should be noted that, in the data drivers shown in FIGS. 3, 4 and 5, the time slots R:ON, G:ON and B:ON are ⅓ of the scan duration, which results in a relatively high switching rates of the gamma multiplexer and the switches.

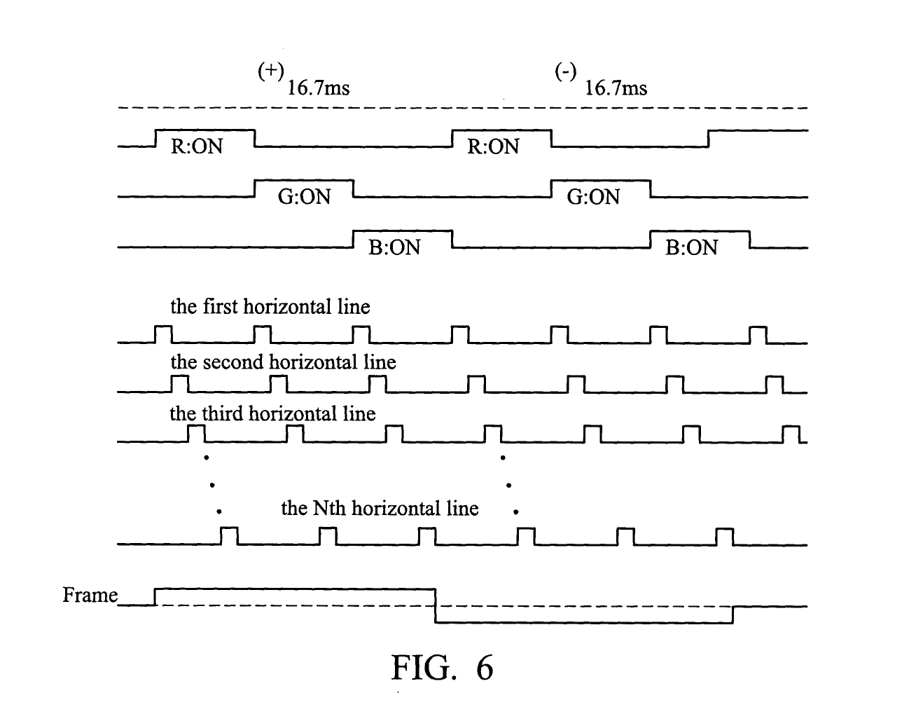

FIG. 6 is a diagram showing the timing of signals used in a data driver according to a fourth embodiment of the invention, which has prolonged time slots. The data driver receives image data with a format the same as that used in FIG. 5 but having time slots equal to ⅓ of the frame time. That is to say, each image frame is divided into three sub-frames respectively of three primary colors. The sub-frames of red, green, and blue correspond to the time slots R:ON, G:ON and B:ON respectively. In one sub-frame time or time slot, the DAC 3a receives the image data of and gamma reference voltage for one primary color, and the unit gain buffer 5a outputs the calibrated image signal of one primary color which is sent to a corresponding data line by the switches. The sub-frame rate must be 3 times that of the frame rate. For example, for a 60 Hz display, the sub-frame rate must be 180 Hz. This results in a time slot of about 5.6 ms, which is much longer than 6.9 μs used in the data drivers of FIGS. 3, 4 and 5.

In conclusion, by dividing a frame or scan duration into three sub-periods respectively for the three primary colors, the present invention provides a data driver applying gamma corrections with different gamma reference voltages to image data of the three primary colors, whereby a optimal calibrated color image with color temperature adjustable can be generated.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A data driver of a display forming an image frame by sequentially scanning horizontal lines, the data driver comprising:
a shift register receiving image data of three primary colors in serial and outputting the image data of the three primary colors in parallel within each of scan durations of the horizontal lines;
a sample and hold register acquiring the image data from the shift register;
a gamma multiplexer outputting gamma reference voltages for the three primary colors in a sequence of the primary colors within each of the scan durations of the horizontal lines;
three digital-to-analog converters for gamma calibration, receiving the image data of the three primary colors from the sample and hold register and the gamma reference voltages for the three primary colors from the gamma multiplexer, and outputting calibrated image signals of the three primary colors, respectively; and
three buffers respectively receiving the calibrated image signals of the three primary colors from the three digital-to-analog converters, in the sequence of the primary colors.

2. A data driver of a display forming an image frame by sequentially scanning horizontal lines, the data driver comprising:
a shift register receiving image data of three primary colors in serial and outputting the image data of the three primary colors in parallel within each of scan durations of the horizontal lines;
a sample and hold register acquiring the image data of the three primary colors from the shift register;
a first multiplexer receiving the image data of the three primary colors from the sample and hold register and outputting them in a sequence of the primary colors within each of the scan durations of the horizontal lines;
a second multiplexer outputting gamma reference voltages for the three primary colors in the sequence of the primary colors within each of the scan durations of the horizontal lines;
a digital-to-analog converter for gamma calibration, receiving the image data from the first multiplexer and the gamma reference voltages from the second multiplexer, and outputting calibrated image signals of the three primary colors; and
a buffer receiving the calibrated image signals from the digital-to-analog converter and outputting the calibrated image signals in the sequence of the primary colors.

3. A data driver of a display forming an image frame by sequentially scanning horizontal lines, the data driver comprising:
a shift register receiving and outputting image data of the three primary colors in a sequence of the primary colors within a scan duration of one of the horizontal lines;
a sample and hold register acquiring the image data from the shift register;
a gamma multiplexer outputting gamma reference voltages for the primary color in the sequence of the primary colors;
a digital-to-analog converter for gamma calibration, receiving the image data from the sample and hold register and the gamma reference voltages from the gamma multiplexer, and outputting calibrated image signals of the three primary colors; and
a buffer receiving the calibrated image signals from the digital-to-analog converter and outputting the calibrated image signals in the sequence of the primary colors.

4. A data driver of a display forming an image frame composed of sub-frames of three primary colors by sequentially scanning horizontal lines for each sub-frame, the data driver comprising:
a shift register receiving and outputting image data of one of the three primary colors within each of scan durations of the horizontal lines;
a sample and hold register acquiring the image data from the shift register;
a gamma multiplexer outputting gamma reference voltages for the primary color to which the image data from the shift register belongs;
a digital-to-analog converter for gamma calibration, receiving the image data from the sample and hold register and the gamma reference voltage from the gamma multiplexer, and outputting a calibrated image signal; and
a buffer receiving the calibrated image signal from the digital-to-analog converter.
